(19) United States
(12) Patent Application Publication
(10) Pub. No.: US 2005/0191537 A1
(43) Pub. Date: Sep. 1, 2005

(54) Fuel cell gasket having an integrated sensor

(76) Inventor: Mark Allen Belchuk, Windsor (CA)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/789,768

(22) Filed: Feb. 27, 2004

(51) Int. Cl. H01M 2/08; H01M 8/02

(52) U.S. Cl. 429/35; 429/36

(57) ABSTRACT

A gasket having an integrated sensor is provided for use in a fuel cell assembly. The gasket having a generally planar form and including a protruding portion extending outwardly in a direction substantially planar to a top surface of the gasket; and a sensor formed on the protruding portion of the gasket.

### FIELD OF THE INVENTION

This invention relates generally to gaskets and more particularly to a gasket having an integrated sensor for monitoring conditions associated with a fuel cell.

### BACKGROUND OF THE INVENTION

A fuel cell is an electrochemical energy converter that includes two electrodes placed on opposite surfaces of an electrolyte. In one form, an ion-conducting polymer electrolyte membrane is disposed between two electrode layers (also sometimes called gas diffusion layers), with layers of a catalyst material between the membrane and the electrode layers, to form a membrane electrode assembly (MEA). The MEA is used to promote a desired electrochemical reaction from two reactants. One reactant, oxygen or air, passes over one electrode while hydrogen, the other reactant passes over the other electrode. The oxygen and hydrogen combine to produce water, and in the process generate electricity and heat.

An individual cell within a fuel cell assembly includes a MEA placed between a pair of separator plates (also sometimes called flow field plates). The separator plates are typically fluid impermeable and electrically conductive. Fluid flow passages or channels are formed adjacent to each plate surface at an electrode layer to facilitate access of the reactants to the electrodes and the removal of the products of the chemical reaction. A plurality of individual cells are commonly bundled together to form a fuel cell stack.

In such fuel cells, the rate of hydrogen flow to the fuel cell is not directly monitored. That is, a hydrogen sensor is not located directly upstream of the fuel cell. In such a fuel cell system, it is important to match the load being demanded of the fuel cell with the rate at which hydrogen is supplied to the fuel cell. If more current is attempted to be drawn out of the fuel cell than it is capable of supplying, then it is possible to significantly degrade the fuel cell stack. As a fuel cell deteriorates, it is possible to incur a permanent reverse polarity. In this situation, the fuel cell begins acting as a resistor and will start heating up. As the cell continues to heat up, it may adversely affect operation of an adjacent cell and, possibly melt the components of the fuel cell.

Although it is possible to determine an overall voltage measure for a fuel cell stack, this does not necessary indicate the occurrence of a problem with a given fuel cell within the stack. For example, a small voltage drop occurring across a number of fuel cells could not be distinguished from a relatively large voltage drop across one problematic fuel cell within the stack.

Thus, it is desirable to provide a technique for monitoring the voltage and other operational parameters associated with each fuel cell in a stack.

### SUMMARY OF THE INVENTION

In accordance with the present invention, a gasket having an integrated sensor is provided for use in a fuel cell assembly. The gasket having a generally planar form and including a protruding portion extending outwardly in a direction substantially planar to a top surface of the gasket; and a sensor formed on the protruding portion of the gasket.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic, perspective view of an exemplary embodiment of a gasket for use in a fuel cell assembly in accordance with the present invention;

FIG. 2A is a top view of the exemplary gasket having an integrated sensor device in accordance with the present invention;

FIG. 2B is a partial, top view of an exemplary embodiment of integrated sensor device coupled to the gasket in accordance with the present invention;

FIG. 3 is a partial, side view of the sensor device in accordance with the present invention;

FIGS. 4A and 4B are top views of an alternative embodiment of a gasket having an integrated sensor device in accordance with the present invention;

FIG. 5 is a schematic, perspective view illustrating an exemplary connector attached to the gasket of the present invention;

FIG. 6 is a schematic, exploded, perspective view of an exemplary individual fuel cell of a fuel cell assembly prior to sealing the gaskets together; and

FIG. 7 is a partial, sectional view of a gasket and membrane electrode assembly of the exemplary fuel cell assembly.

### DETAILED DESCRIPTION OF THE PREFERRED EMBODIMENTS

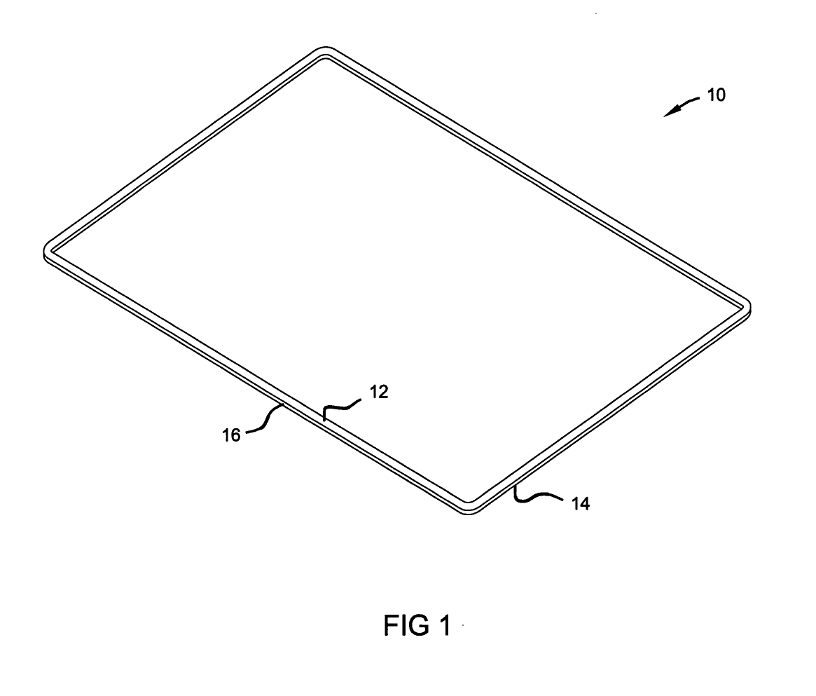

FIGS. 1-3 illustrates an exemplary gasket 10 for use in a fuel cell assembly. In an exemplary embodiment, the gasket 10 is in a planar form having an outer perimeter area surrounding an opening. Thus, the gasket 10 is defined by a top surface 12, a bottom surface 14 and an outer side surface 16. However, it is readily understood that the gasket may take other forms which are configured to mount against an ion-conducting, electrolyte membrane of a fuel cell as is well known in the art. Since the relative thickness of the gasket is very thin, it has been depicted schematically in order to aid in describing the present invention. Furthermore, it is readily understood that the dimensions for the gasket may vary according to the particular application of the fuel cell.

In accordance with the present invention, the gasket 10 further includes an integrated sensing device 20 for monitoring the voltage and/or other operational parameters associated with a given fuel cell. In an exemplary form, the sensor 20 is comprised of a conductor pattern 22 formed on at least one thin dielectric layer 24. However, the conductor pattern 22 is preferably sandwiched between two dielectric films 24, 26 having an overall thickness typically less than 0.5 mm. Although not limited thereto, the conductor material may be copper or carbon and the dielectric material may be either, polyester, polyimide, polyethylene napthalate, polyetherimide, or some other known polymer substrate.

The conductor pattern 22 may be created by printing a conductive ink on a first dielectric layer 24. Alternatively, the conductor pattern may be formed by imaging and etching, or mechanically cutting a metal foil on a flexible base material. A second dielectric film 26 may then be bonded to the exposed conductor surface by either vibration welding, friction welding, pressure sensitive adhesive, or heat staking. It is readily understood that other known repetitive manufacturing processes may also be employed.

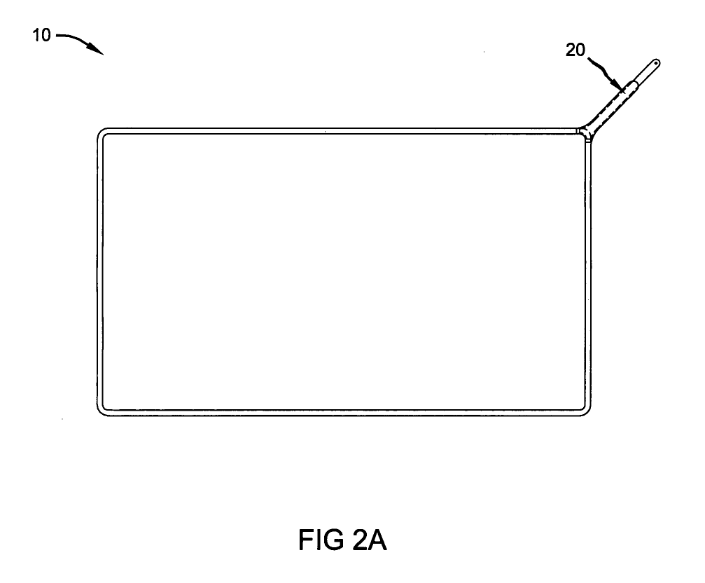

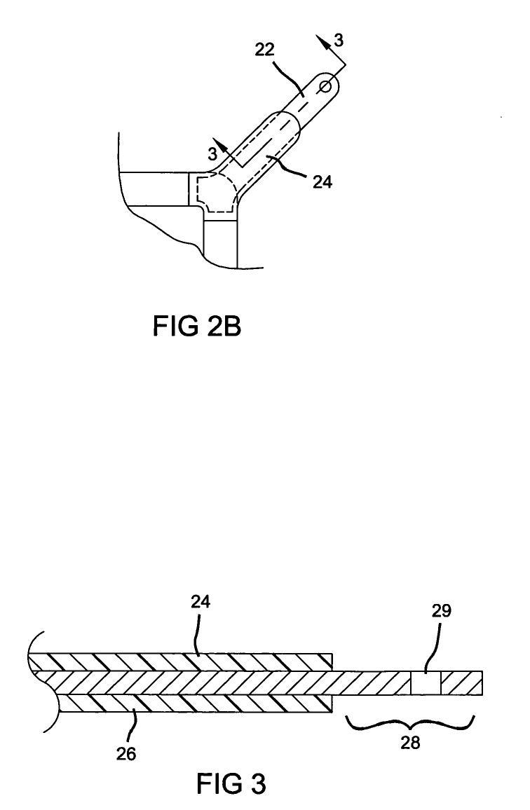

In one exemplary embodiment, the sensor 20 is coupled to an exterior surface of the gasket. In particular, the sensor 20 is coupled by an adhesive to the top surface of the gasket and protrudes outwardly in a direction substantially planar to the top surface or the bottom surface of the gasket as shown in FIGS. 2A and 2B. In this configuration, the conductor contact pressure can be applied through the elastomer seal pressure.

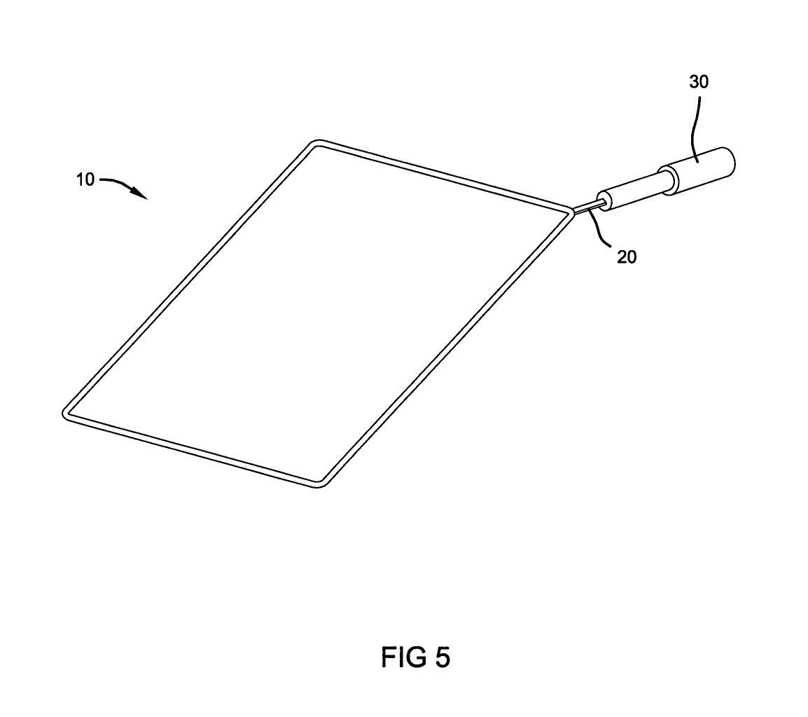

To terminate the sensor, a connection terminal 28 is formed at the end of the sensor distal from where the sensor couples to the gasket as shown in FIG. 3. The connection terminal is formed by a portion of the conductor pattern which projects out from the dielectric layers 24, 26. A conventional thru-hole connector 30 may then be attached via a thru-hole 29 formed in the connection terminal 28 as shown in FIG. 5. It is readily understood that other types of connectors, such as crimped contacts and displacement connectors or zero insertion force connectors, may also be attached to the sensor.

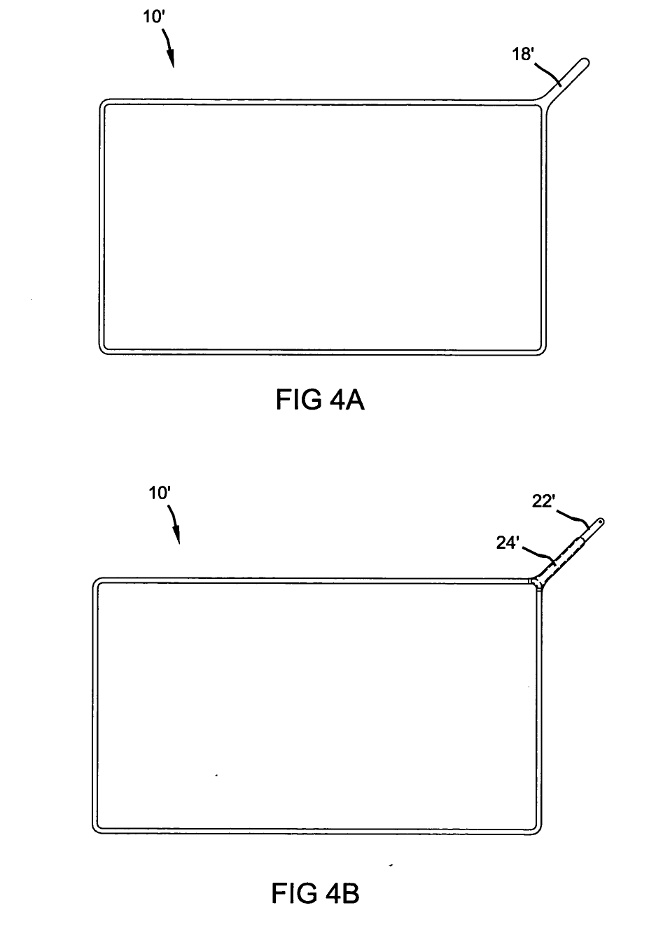

In an alternative embodiment, the gasket 10′ is formed to include an integral protruding portion 18′ that extends outwardly from the gasket as shown in FIG. 4A. Referring to FIG. 4B, the conductor pattern 22′ is formed onto the protruding portion 18′ of the gasket 20′ in a manner described above. In other words, the protruding portion 18′ serves as the first dielectric layer 26′ of the sensor. A second dielectric film 24′ is then bonded to the exposed conductor surface by either vibration welding, friction welding or heat staking as noted above, thereby encasing the conductor pattern 22′ between two dielectric layers 24′, 26′.

In operation, the conductor pattern preferably serves as a voltage sensor for the fuel cell. To facilitate operation, the design of the conductor pattern may further incorporate signal-conditioning circuitry, such as resistors and/or current limiting components, as is well known in the art.

A similar construction may be employed for other types of sensing devices. For instance, a temperature sensitive ink may be substituted for the conductive ink or combined to form a temperature sensor for the fuel cell. Likewise, a pressure sensitive ink may be substituted for the conductive ink or combined to form a pressure sensor for the fuel cell. It is envisioned that other types of sensing devices are also within the broader scope of the present invention.

Moreover, multiple sensing functions may be combined into a single gasket. For instance, it is envisioned that patterns of ink may be disposed adjacent to each other on a relatively wider dielectric layer. Alternatively, multiple conductive layers may be stacked having separating dielectric layers formed between them. It is envisioned that other constructions having multiple sensing functions are also within the scope of the present invention.

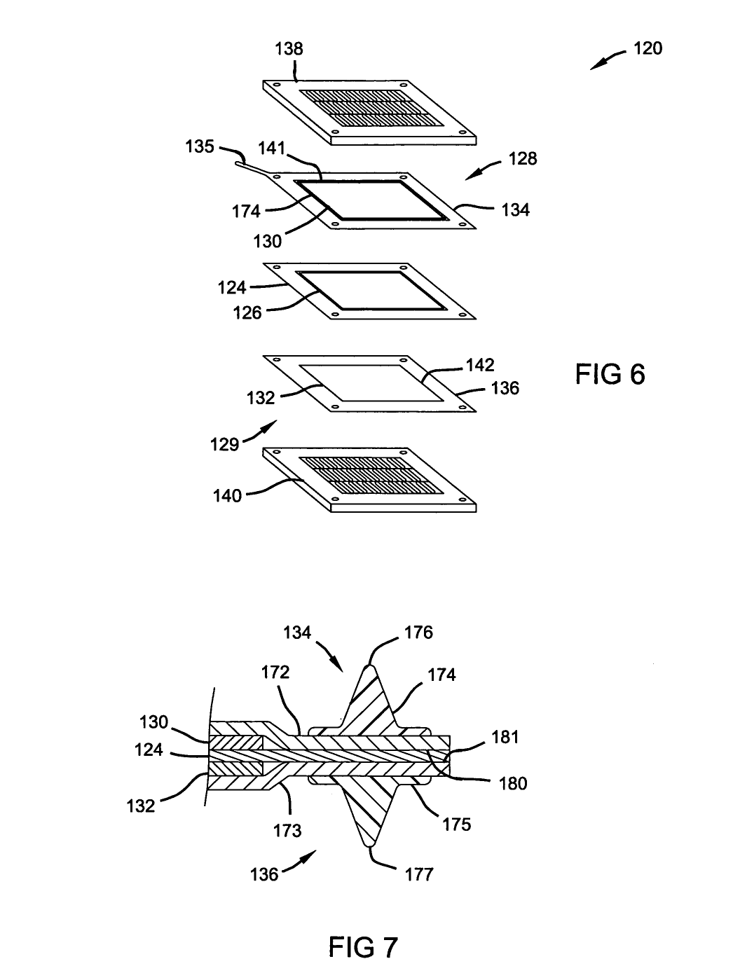

FIGS. 6 and 7 illustrate an individual fuel cell 120 for use in a fuel cell assembly. The individual fuel cell 120 serves as an example of a fuel cell that may employ the gasket of the present invention. While the following description sets forth a particular fuel cell assembly, it is readily understood that the gasket of the present invention may be adapted for use with other types of fuel cell assemblies.

The individual cell 120 preferably includes a gasket unitized membrane electrode assembly (MEA) 122, (although the gasket may be separate rather than unitized, if so desired). The MEA 122 is made up of a membrane 124, with a layer of catalyst material 126, on both sides of the membrane 124. The MEA also includes a first gas diffusion layer (GDL) 130 and a second GDL 132 on either side of the layers of catalyst material 126, as well as a first gasket 134 and a second gasket 136, secured around the perimeters 141, 142 of the first GDL 130 and the second GDL 132, respectively. It is envisioned that at least one of the gaskets 134, 136 included an integrated sensing device 135 in accordance with the present invention.

Preferably, the gaskets 134, 136 are secured to the GDLs 130, 132 by adhesive, although other means of securing may be used if so desired, such as molding each gasket to its GDL. Each GDL 130, 132 and its corresponding gasket 134, 136 forms a unitized seal-diffusion assembly 128, 129 respectively. A first separator plate 138 mounts against the first gasket 134 and the first GDL 130, and a second separator plate 140 mounts against the second gasket 136 and the second GDL 132, in order to form the individual cell 120. In addition, the components of the cell 120 are generally symmetric about the membrane 124.

The membrane 124 is preferably an ion-conducting, polymer electrolyte membrane, as generally employed in this type of fuel cell application. The catalyst material 126 is preferably platinum or other suitable catalyst material for a typical polymer electrode membrane type of fuel cell application. The first and second GDLs 130, 132 are preferably a carbonized fiber, or may be another suitable gas permeable material for use as an electrode in a fuel cell. The MEA 122 can include a catalyzed membrane with GDLs assembled thereto, or a membrane assembled between two catalyzed GDLs, each of which is known to those skilled in the art.

The gaskets 134, 136 are each preferably a laminated gasket with a thin, flexible carrier 172, 173 upon which an elastomeric seal 174, 175, respectfully, is secured—with each elastomeric seal 174, 175 preferably including a sealing bead 176, 177 projecting therefrom. Each carrier 172, 173 preferably has a thickness of less than 1.0 millimeters and is preferably made from a polymer substrate, such as, for example polyimide or polyester. Each elastomeric seal 174, 175 is preferably molded to its carrier 172, 173 although other means of securing the two may also be employed. The sealing beads 176, 177 are designed to be compressed against the surface of its corresponding separator plate 138, 140 and held with sufficient sealing force to prevent migration of fluid past the seal along the surface of the particular separator plate 138, 140. While the sealing beads 176, 177 are shown in the shape of a triangle, different shapes may also be employed, if so desired.

The membranes 124 generally extend to the perimeter of the unitized seal-diffusion assemblies 128, 129. During assembly of the unitized MEA 122, the unitized seal-diffusion assemblies 128, 129 are aligned with and brought together around the membrane 124. These components are then held together while a heat staking process is employed to secure and seal the first surfaces 180, 181 of the gaskets 134, 136 respectively, to the membrane 124. Alternatively, a vibration welding process is employed to secure and seal the first surfaces 180, 181 to the membrane 124. Thus, the unitized MEA 122 is held together and sealed about its perimeter without applying an adhesive thereabout. After this assembly step, then the separator plates 138, 140 are assembled in order to form a cell 120.

The description of the invention is merely exemplary in nature and, thus, variations that do not depart from the gist of the invention are intended to be within the scope of the invention. Such variations are not to be regarded as a departure from the spirit and scope of the invention.

1. A gasket having an integrated sensor for a fuel cell, comprising:
a gasket having an exterior surface;
a sensor coupled to the exterior surface of the gasket and protruding outwardly therefrom, the sensor being comprised of a conductor disposed on at least one dielectric layer.

2. The gasket of claim 1 wherein the gasket having a planar form with a top surface, a bottom surface and a side perimeter surface, such that the sensor is coupled to at least one of the top surface and the bottom surface of the gasket and protrudes in a direction substantially planar to the top surface of the gasket.

3. The gasket of claim 1 wherein the sensor is coupled to the gasket by an adhesive.

4. The gasket of claim 1 wherein the conductor is sandwiched between two dielectric films.

5. The gasket of claim 1 wherein the conductor projects out from the two dielectric films at a location distal from where the sensor couples to the gasket, thereby forming a connection terminal for the sensor.

6. The gasket of claim 4 wherein the two dielectric films are bonded to the conductor by at least one of vibration welding, friction welding, heat staking and through a pressure sensitive adhesive.

7. The gasket of claim 1 wherein the conductor is comprised of a material selected from the group consisting of carbon, gold and copper.

8. The gasket of claim 1 wherein the dielectric layer is comprised of a material selected from the group consisting of polyester, polyimide, polyetherimide, and polyethylene napthalate.

9. The gasket of claim 1 wherein the gasket is configured to mount against an ion-conducting, electrolyte membrane of the fuel cell.

10. A gasket having an integrated sensor for a fuel cell, comprising:
a gasket having a planar form with a top surface, a bottom surface and a side perimeter surface, the gasket further including a protruding portion extending outwardly in a direction substantially planar to the top surface of the gasket; and
a sensor formed on the protruding portion of the gasket.

11. The gasket of claim 10 wherein the sensor is comprised of a conductor formed on protruding portion of the gasket.

12. The gasket of claim 10 wherein the conductor is sandwiched between two dielectric films and projects out from the two dielectric films at a location distal from where the protruding portion extends from the remander of the gasket, thereby forming a connection terminal for the sensor.

13. The gasket of claim 12 wherein the two dielectric films are bonded to the conductor by at least one of vibration welding, friction welding, heat staking, and through a pressure sensitive adhesive.

14. The gasket of claim 10 wherein the conductor is comprised of a material selected from the group consisting of carbon, gold and copper.

15. The gasket of claim 10 is comprised of a material selected from the group consisting of polyester, polyimide, polyetherimide, and polyethylene napthalate.

16. The gasket of claim 10 wherein the gasket is configured to mount against an ion-conducting, electrolyte membrane of the fuel cell.
